(19) United States
(12) Patent Application Publication
(10) Pub. No.: US 2009/0018830 A1
(43) Pub. Date: Jan. 15, 2009

(54) SPEECH CONTROL OF COMPUTING DEVICES

(75) Inventor: Ezechias EMMANUEL, Barsinghausen (DE)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: VANDINBURG GMBH, Hannover (DE)

(21) Appl. No.: 11/843,982

(22) Filed: Aug. 23, 2007

(30) Foreign Application Priority Data
Jul. 11, 2007 (EP) 07 013 604.9

(51) Int. Cl. G10L 15/26; G10L 11/00

(52) U.S. Cl. 704/235; 704/275; 704/E15.043

(57) ABSTRACT

The invention relates to techniques of controlling a computing device via speech. A method realization of the proposed techniques comprises the steps of transforming speech input into a text string comprising one or more input words; performing a context-related mapping of the input words to one or more functions for controlling the computing device; and preparing an execution of the identified function. Another realization is related to a remote speech control of computing devices.

### TECHNICAL FIELD

The invention relates to techniques for controlling computing devices via speech and is applicable to different computing devices such as mobile phones, notebooks and other mobile devices as well as personal computers, gaming consoles, computer-controlled machinery and other stationary devices.

### BACKGROUND

Controlling computing devices via speech provides for a human user or operator a fast and easy way of interacting with the device; for example, the time-consuming input of commands via keypad or keyboard can be omitted and the hands are free for other purposes such as moving a mouse or control lever or performing manual activities like carrying the device, carrying goods, etc. Therefore, speech control may conveniently be applied for such different operations as controlling mobile phones, gaming consoles or household appliances, but also for controlling machines in an industrial environment.

In principle, today's speech control systems require that the user inputs a command via speech which he or she would otherwise enter by typing or by clicking on an appropriate button. The input speech signal is then provided to a speech recognition component which recognizes the spoken command. The recognized command is output in a machine-readable form to the device which is to be controlled.

In some more detail, a typical speech control device may store some pre-determined speech samples representing, for example, a set of commands. A recorded input speech signal is then compared to the stored speech samples. As an example, a probability calculation block may determine, based on matching the input speech signal to the stored speech samples, a probability value for each of the stored samples, the value indicating the probability that the respective sample corresponds to the input speech signal. The sample with the largest probability value will then be selected.

Each stored speech sample may have an executable program code associated therewith, which represents the respective command in a form that is executable by the computing device. The program code will then be provided to a processor of the computing device in order to perform the recognized command.

Speech recognition is notoriously prone to errors. In some cases, the speech recognition system is not able to recognize a command at all. Then the user has to decide whether to repeat the speech input or to manually input the command. Often, a speech recognition system does not recognize the correct command, such that the to user has to cancel the wrongly recognized command before repeating the input attempt.

In order to achieve a high identification rate, the user must be familiar with all the commands and should speak in a particular way to facilitate speech recognition. Many speech recognition systems require a training phase. Elaborated algorithms for representing speech and matching speech samples with each other have been developed in order to allow a determination of the correct command with a confidence level sufficient for a practical deployment. Such developments have led to ever more complex systems requiring a considerable amount of processing resources. For a long time, the performance of speech recognition in personal computers and mobile phones has essentially been limited by the processing power available in these computing devices.

### SUMMARY

There is a need for a technique of controlling a computing device via speech which is easy to use for the user and enables a determination of the correct commands with high confidence while avoiding the use of excessive processing resources.

In order to meet with this need, as a first aspect a method of controlling a computing device via speech is proposed. The method comprises the following steps: Transforming speech input into a text string comprising one or more input words; comparing each one of the one or more input words with context mapping words in a context mapping table, in which at least one context mapping word is associated with at least one function for controlling the computing device and at least one of the at least one function is associated with multiple context mapping words; identifying, in case at least one of the one or more input words matches with one of the context mapping words, the function associated with the matching context mapping word; and preparing an execution of the identified function.

The computing device may in principle be any hardware device which is adapted to perform at least one instruction. Thus, a ‘computing device’ as understood herein may be any programmable device, for example a personal computer, notebook, phone, or control device for machinery in an industrial area, but also other areas such as private housing; e.g. the computing device may be a coffee machine. A computing device may be a general purpose device, such as a personal computer, or may be an embedded system, e.g. using a microprocessor or microcontroller within an Application-Specific Integrated Circuit (ASIC) or Field-Programmable Gate Array (FPGA). The term ‘computing device’ is intended to include essentially any device which is controllable, e.g. via a hardware and/or software interface such as an Application Programming Interface (API), and via one or more machine-readable instructions in the form of, e.g., an executable code which may be generated by a compiler, assembler or similar tool in any programming language, macro language, interpreter language, etc. The executable code may be in binary form or any other machine-readable form. The computing facility may be represented, e.g., in hardware, firmware, software or a combination thereof. For example, the computing device may comprise a microprocessor for controlling other parts of the device such as, e.g., a display, an actuator, a signal generator, a remote device, etc. The function(s) for controlling the computing device may include some or all commands for the operating system of the computing device or for an application executed on the computing device, but may further include functions which are not directly accessible via a user interface but require an input on an expert level such as via a system console or command window. The functions may express functionality in a syntax specific for an operating system, an application, a programming language, a macro language, etc.

A context mapping word may represent the entire function or one or more aspects of the functionality of the function the context mapping word is associated with. The context mapping word may represent the aspect in textual form. A context mapping word may be directly associated with a function or may additionally or alternatively be indirectly associated with a function; for example, the context mapping word may be associated with a function parameter. Multiple context mapping words associated with a particular function may be provided in order to enable that the function may be identified from within different contexts. For instance, the context mapping words associated with a function may represent different names (alias names) of the function the context mapping words are associated with, or may represent technical and non-technical names, identifications or descriptions of the function or aspects of it. As a further example, the context mapping words may represent the function or one or more aspects of it in different pronunciations (e.g., male and female pronunciation), dialects, or human languages.

The associations of context mapping words and functions (and possibly function parameters) may be represented in the context mapping table in different ways. In one implementation, all controllable functions (or function parameters) may be arranged in one function column (row) of the table. For each function, the associated context mapping words may be arranged in a row (column) corresponding to the position of the function in the function column. In this implementation, one and the same context mapping word appears multiple times in the context mapping table in case it is associated with multiple functions. In another implementation, each context word may be represented only one time in the context mapping table, but the correspondingly associated function appears multiple times. In still other implementations, each context mapping word and each function is represented exactly one time in the context mapping table and the associations between them are represented via links, pointers or other structures known in the field of database technologies.

The identified function may be executed immediately after the identification (or after the entire input text string has been parsed). Alternatively or in addition, the identified function may also be executed at a later time. In one implementation of the method aspect, the function in the context mapping table has executable program code associated with it. The step of preparing the execution of the identified function may then comprise providing an executable program code representing the identified function on the computing device. In other implementations, the step of preparing the execution of the identified function comprises providing a text string representing a call of the identified function. The string may be provided immediately or at a later time to an interpreter, compiler etc. in order to generate executable code.

In one realization, the step of identifying the function comprises, in case an input word matches a context mapping word associated with multiple functions, identifying one function of the multiple functions which is associated with multiple matching context mapping words. This function may then be used as the identified function. The step of comparing each one of the one or more input words with context mapping words may comprise the step of buffering an input word in a context buffer in case the input word matches a context mapping word that is associated with two or more functions. In one implementation, the step of buffering the input word may further comprise to buffer the input word in the context buffer including, for each of the two or more functions or function parameters associated with the input word, an indication of the function or function parameter. The step of identifying the function may then comprise to compare indications of functions or function parameters of two or more input words buffered in the context buffer and to identify corresponding indications.

One variant of the method aspect may comprise the further step of comparing an input word with function names in a function name mapping table, in which each of the function names represents one of the functions for controlling the computing device. The method in this variant may comprise the further step of identifying, in case the input word matches with at least a part of a function name, the function associated with the at least partly matching function name. The function name mapping table may further comprise function parameters for comparing the function parameters with input words.

Entries corresponding to the same function or function parameter in the context mapping table and the function name mapping table may be linked with each other. A linked entry in the function name mapping table may be associated with executable program code representing at least a part of a function.

According to one implementation, the method comprises the further steps of comparing input words with irrelevant words in an irrelevant words mapping table; and, in case an input word matches with an irrelevant word, excluding the input word from identifying the function. The irrelevant words mapping table may comprise, for example, textual representations of spoken words such as ‘the’, ‘a’, ‘please’, etc.

In one realization of the method, the step of transforming the speech input into the text string is performed in a speech recognition device and the steps of comparing input words of the text string with context mapping words and identifying the function associated with a matching context mapping word are performed in a control device. The method may then comprise the further step of establishing a data transmission connection between the remote speech recognition device and the control device for transmitting data comprising the text string.

According to a second aspect, a method of controlling a computing device via speech is proposed, wherein the method is performed in a control device and in a speech input device remotely arranged from the control device. The method comprises the steps of transforming, in the speech input device, speech input into speech data representing the speech input; establishing a data transmission connection for transmitting the speech data between the remotely arranged speech input device and the control device; and converting, in the control device, the speech data into one or more control commands for controlling the computing device.

That the control device and the speech input device are remotely arranged from each other does not necessarily include that these devices are arranged spatially or geographically remote from each other. For example, both devices may be located in the same building or room, but are assumed to be remotely arranged in case the data transmission connection is a connection configured for transmitting data between separate devices. For example, the data transmission connection may run over a local area network (LAN), wide area network (WAN), and/or a mobile network. For example, in case a mobile phone is used as speech input device and the speech input is transmitted using VoIP over a mobile network towards a notebook having installed a speech recognition/control application, the mobile phone and the notebook are assumed to be remotely arranged to each other even if they are physically located nearby to each other.

According to a third aspect, a computer program product is proposed. The computer program product comprises program code portions for performing the steps of any one of the method aspects described herein when the computer program product is executed on one or more computing devices. The computer program product may be stored on a computer readable recording medium, such as a permanent or re-writeable memory within or associated with a computing device or a removable CD-ROM or DVD. Additionally or alternatively, the computer program product may be provided for download to a computing device, for example via a data network such as the Internet or a communication line such as a telephone line or wireless link.

According to a fourth aspect, a control device for controlling a computing device via speech is proposed. The control device comprises a speech recognition component adapted to transform speech input into a text string comprising one or more input words; a matching component adapted to compare each one of the one or more input words with context mapping words in a context mapping table, in which at least one context mapping word is associated with at least one function for controlling the computing device and at least one of the at least one function is associated with multiple context mapping words; an identification component adapted to identify, in case at least one of the one or more input words matches with one of the context mapping words, the function associated with the matching context mapping word; and a preparation component adapted to prepare an execution of the identified function. The control device may be implemented on the computing device, which may be a mobile device such as a notebook, mobile phone, handheld, wearable computing devices such as head-up display devices, etc., or a stationary device such as a personal computer, household appliance, machinery, etc.

According to a fifth aspect, a control device for controlling a computing device via speech is proposed, which comprises a data interface adapted to establish a data transmission connection between a remote speech input device and the control device for receiving data comprising a text string representing speech input from the remote speech input device, wherein the text string comprises one or more input words; a matching component adapted to compare each one of the one or more input words with context mapping words in a context mapping table, in which at least one context mapping word is associated with at least one function for controlling the computing device and at least one of the at least one function is associated with multiple context mapping words; an identification component adapted to identify, in case at least one of the one or more input words matches with one of the context mapping words, the function associated with the matching context mapping word; and a preparation component adapted to prepare an execution of the identified function.

According to a sixth aspect, a system for controlling a computing device via speech is proposed. The system comprises a control device and a speech input device. The speech input device is adapted to transform speech input into speech data representing the speech input. The control device is adapted to convert the speech data into one or more control commands for controlling the computing device. Each of the speech input device and the control device comprises a data interface adapted to establish a data transmission connection for transmitting the speech data between the remotely arranged speech input device and the control device.

A seventh aspect is related to a speech input device, wherein the speech input device is adapted for inputting and transforming speech input into speech data representing the speech input and the speech input device comprises a data transmission interface. According to the seventh aspect, use of the speech input device is proposed for establishing, via the data transmission interface, a data transmission connection for transmitting the speech data to a remote computing device, wherein the computing device transforms the speech data into control functions for controlling the computing device.

An eighth aspect is related to a computing device including a speech recognition component for transforming speech input into control functions for controlling the computing device and a data reception interface for establishing a data reception connection. According to the eighth aspect, use of the computing device is proposed for receiving, via the data reception interface, speech data from a remote speech input device and for transforming the received speech data into control functions for controlling the computing device.

### BRIEF DESCRIPTION OF THE DRAWINGS

In the following, the invention will further be described with reference to exemplary embodiments illustrated in the figures, in which:

FIG. 1 schematically illustrates an embodiment of a control device for controlling a computing device via speech;

FIG. 2 illustrates an embodiment of a context mapping component of the control device of FIG. 1;

FIG. 3 illustrates an embodiment of a context mapping table for use with the context mapping component of FIG. 2;

FIG. 4 illustrates an embodiment of a function name mapping table for use with the context mapping component of FIG. 2;

FIG. 5 illustrates an example of a text string representing a speech input;

FIG. 6 illustrates a content of a context buffer used by the context mapping component of FIG. 2 when parsing the text string of FIG. 5;

FIGS. 7A-7C illustrate contents of an instruction space used by the context mapping component of FIG. 2;

FIG. 8 schematically illustrates an embodiment of a control system for controlling a computing device via speech;

FIG. 9 illustrates a first embodiment of a method of controlling a computing device via speech;

FIG. 10 illustrates an embodiment of a context mapping procedure which may be performed within the framework of the method of FIG. 9; and

FIG. 11 illustrates a second embodiment of a method of controlling a computing device via speech.

### DETAILED DESCRIPTION

In the following description, for purposes of explanation and not limitation, specific details are set forth, such as specific implementations of control devices and computing devices, in order to provide a thorough understanding of the current invention. It will be apparent to one skilled in the art that the current invention may be practised in other embodiments that depart from these specific details. For example, the skilled artisan will appreciate that the current invention may be practiced using wireless connections between different devices and/or components instead of the hardwired connections discussed below to illustrate the present invention. The invention may be practised in very different environments. This may include, for example, network-based and/or client-server based scenarios, in which at least one of a speech recognition component, a context mapping component and, e.g., an instruction space for providing an identified function is accessible via a server in a Local Area Network (LAN) or Wide Area Network (WAN).

Those skilled in the art will further appreciate that functions explained herein below may be implemented using individual hardware circuitry, using software functioning in conjunction with a programmed microprocessor or a general purpose computer, using an application specific integrated circuit (ASIC) and/or using one or more digital signal processors (DSPs). It will also be appreciated that when the current invention is described as a method, it may also be embodied in a computer processor and a memory coupled to a processor, wherein the memory is encoded with one or more programs that perform the methods disclosed herein when executed by the processor.

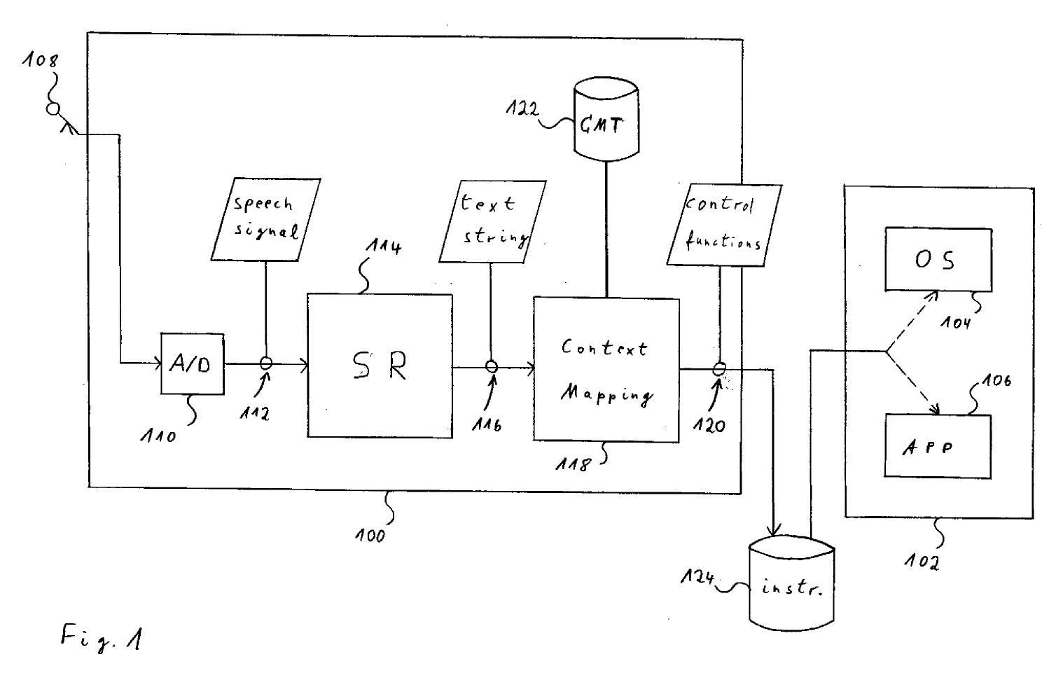

FIG. 1 schematically illustrates an embodiment of a control device 100 for controlling a computing device 102 via speech. The computing device 102 may be a personal computer or similar device including an operating system (OS) 104 and an application (APP) 106. The computing device 102 may or may not be connected with other devices (not shown).

The control device 100 includes a built-in speech input device comprising a microphone 108 and an Analogue-to-Digital (A/D) converter 110 which digitizes an analogue electric signal from the microphone 108 representing a speech input by a human user. The A/D converter 110 provides the digital speech signal 112 to a Speech recognition (SR) component 114. The SR component 114 operates to transform the speech signal 112 into a text string 116 which represents the speech input in a textual form. The text string 116 comprises a sequence of input words.

The text string 116 is provided to a context mapping component 118, which converts the text string 116 into one or more control functions 120 for controlling the computing device 102. The control functions 120 may comprise, e.g., one or more control commands with or without control parameters. The context mapping component 118 operates by accessing one or more databases; only one database is exemplarily illustrated in FIG. 1, which stores a context mapping table (CMT) 122. The operation of the context mapping component 118 will be described in detail further below.

The control function or functions 120 resulting from the operation of the context mapping component 118 are stored in an instruction space 124. During or after the process of transforming and converting a speech input into the functions 120, either the operating system 104 or the application 106, or both, of the computing device 102 may access the instruction space 124 in order to execute the instructions stored therein, i.e. the control functions which possibly include one or more function parameters. The functions 120 stored in the instruction space 124 may for example be represented in textual form as function calls, e.g., conforming to the syntax of at least one of the operating system 104 and the application(s) 106. For example, for the application 106 a specific software-API may be defined, to which the functions (instructions) 120 conform. As another example, the instruction space 124 may also store the control functions 120 in the form of a source code (one or more programs), which has to be transformed into an executable code by a compiler, assembler, etc. before execution. As still another example, the control functions may be represented in the form of one or more executable program codes, which do not require any compilation, interpretation or similar steps before execution.

The control device 100 and the computing device 102 may be implemented on a common hardware. For example, the control device 100 may be implemented in the form of software on a hardware of the computing device 102 running the operating system 104 and one or more applications 106. In other implementations, the control device 100 is implemented at least in part on a separate hardware. For example, software components of the control device 100 may be implemented on a removable storage device such as an USB stick. In another example, the control device is adapted to store the control functions 120 on a removable storage, for example a removable storage disk or stick. The removable storage may then be provided to the computing device 102 in order that the computing device 102 may load the stored control functions into the instruction space 124, which in this scenario belongs to the computing device 102. In still another example, the control device 100 may send the control functions 120 via a wireless or hardwired connection to the computing device 102.

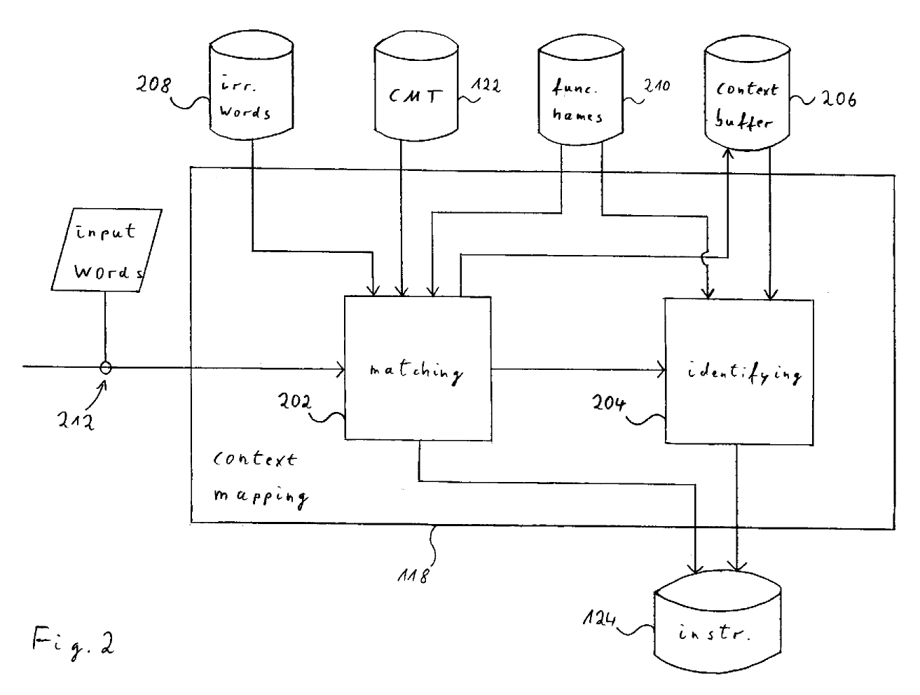

FIG. 2 illustrates in more detail functional building blocks of the context mapping component 118 in FIG. 1. Like reference numerals are used for like components in FIGS. 1 and 2. The context mapping component 118 comprises a matching component 202, an identification component 204 and a number of databases, namely the database storing the context mapping table 122 and further databases for storing a context buffer 206, an irrelevant words mapping table 208 and a function name mapping table 210. Both components 202 and 204 may provide control functions and/or parameters thereof to the instruction space 124 (cf. FIG. 1).

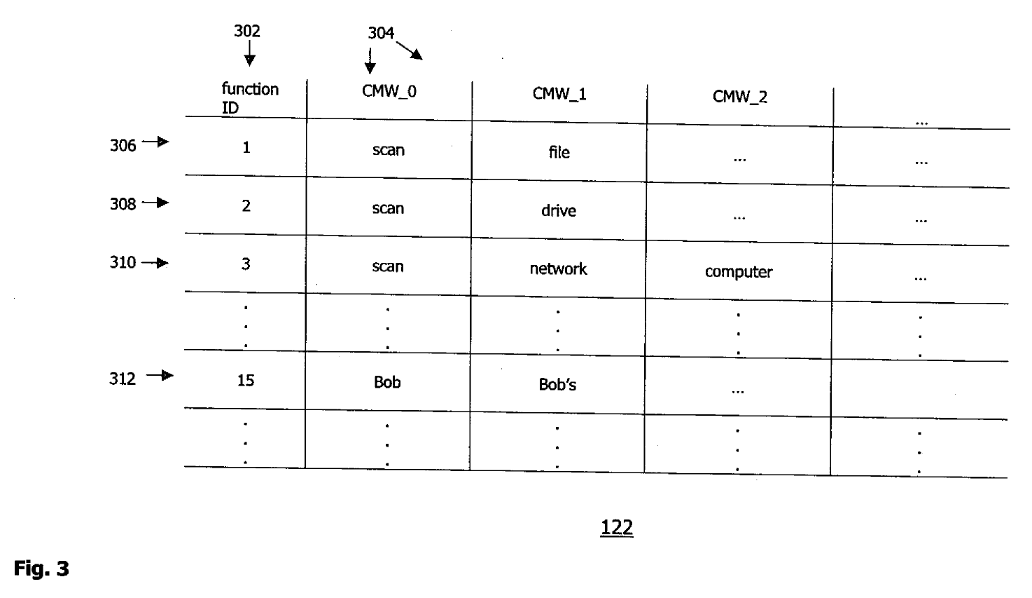

As shown in FIG. 1, the context mapping component 118 may receive a text string 116 from the Speech recognition component 118. The text string may comprise one or more input words 212 (FIG. 2). The matching component 202 is, amongst others, adapted to compare each one of the one or more input words 212 with context mapping words stored in the context mapping table 208. The example context mapping table 122 is in more detail depicted in FIG. 3.

The table 122 in FIG. 3 comprises in column 302 function identification numbers (IDs), wherein each function ID references one and exactly one function which may be performed to control the computing device 102 in FIG. 1. Consequently, each row of the table 122 corresponding to an entry of a function ID in column 302 is assigned to a particular function. Further columns 304 of table 122 are provided for context mapping words (CMW, CMW_0, . . . ). The number of context mapping words associated with a function may be from 1 to a maximum number, which may be given for any particular implementation. For example, the maximum number may be 255.

As an example, the function ID “1” in row 306 of table 122 may refer to a function “ScanFile” which may be performed on the computing device 102 in order to scan all files on the computer fur the purpose of, e.g., finding a particular file. Between 1 and the maximum number of context mapping words may be associated with the function ScanFile. In the simple example table 122, only two context mapping words are associated with this function, namely as CMW_0 the word “scan” and as CMW_1 the word “file”. Similarly, in row 308, the function ID “2” may refer to a function Scan-Drive to scan the drives available to the computing device 102; as context mapping words CMW_0 and CMW_1, the words “scan” and “drive” are associated with this function. In row 310, the function ID “3” may refer to a function “ScanIPaddress”, which may be provided in the computing device 102 to scan a network in order to determine if a particular computer is connected therewith. The context mapping words CMW_0, CMW_1 and CMW_2 associated with this function are the words “scan” “file” and “computer”.

Besides defining associations of context mapping words with functions, a context mapping table may also define associations of context mapping words with function parameters. A corresponding example is depicted in FIG. 3 with row 312 of table 122. The human name “Bob” as context mapping word is associated with ID “15”. The ID may be assigned, e.g., to the IP address of the computer of a human user named Bob. As a further example, in rows 314 various context mapping words are defined which a human user may use to express that a device such a computer is turned or switched on or off. The parameter ID 134 may thus refer to a function parameter “ON” and the parameter ID 135 may refer to a function parameter “OFF”.

The context mapping table 122 in FIG. 3 is structured such that a function (or its ID) is represented in the table only once. Then, a context mapping word relevant for multiple functions may occur several times in the table. For example, the context mapping word “scan” is associated with three functions in table 122, namely the functions referenced with IDs 1, 2, and 3 in lines 306, 308 and 310. Other embodiments of context mapping tables may be based on a different structure. For example, each context mapping word may be represented only once in the table. Then, the functions (or their IDs) would appear multiple times in the table. With such a structure, the CMW “scan” would appear only once, and would be arranged such that the associations with the function IDs 1, 2 and 3 are indicated. The function ID “1” would appear two times in the table, namely to indicate the associations of the CMWs “scan” and “file” with this function. Other mechanisms of representing associations of context mapping words with control functions may also be deployed.

Referring back to FIG. 2, the matching component 202 of control device 118 may also be adapted to employ the irrelevant words mapping table 208 when parsing the input words 212. This table 208 may comprise, in textual form, words which are assumed to be irrelevant for determining control functions. For example, articles such as “the” and words primarily required for grammatical or syntactical reasons in human language sentences such as “for”, “if” etc. may be represented as irrelevant words in the irrelevant words mapping table 208. In case an input word matches with an irrelevant word, the matching component 202 may discard the input word from further processing, such that the word is excluded from identifying the function.

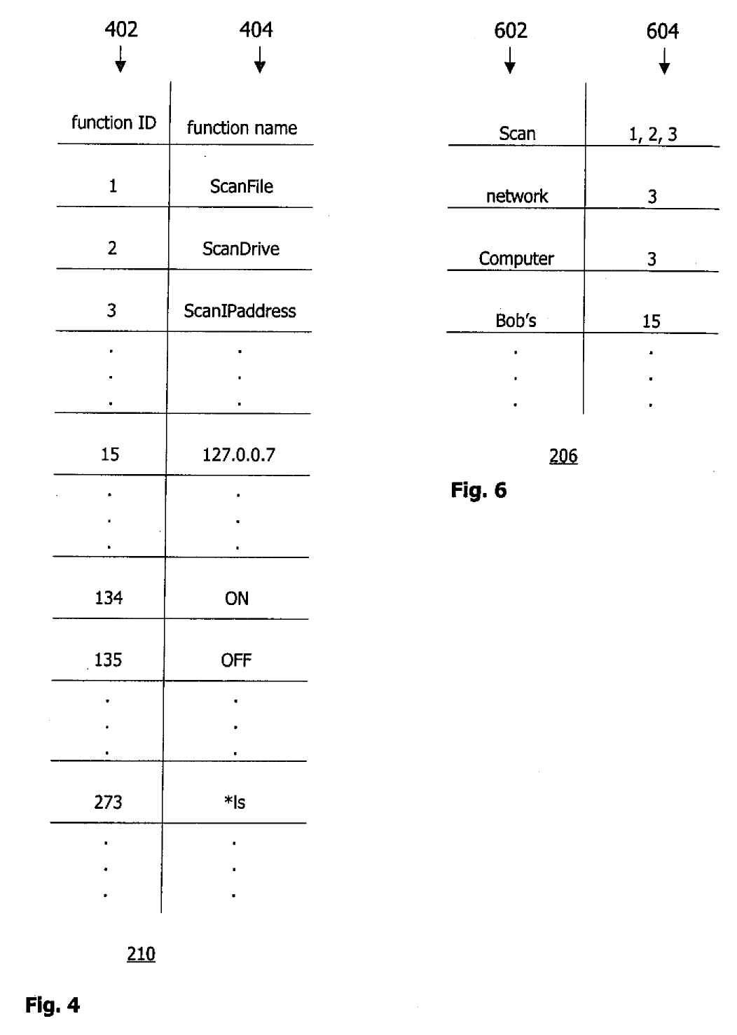

The matching component 202 may further be adapted to employ the function name mapping table 210 when parsing the input words 212. FIG. 4 illustrates an example embodiment 400 of the function name mapping table 210. The table 400 comprises a function ID column 402 similar to column 302 in context mapping table 122 in FIG. 3. A further column 404 comprises, for each of the function IDs in column 402, the associated function name in textual form. For example, the function ID “1” is associated with the function name “ScanFile”, which may represent the file scanning functionality already described above.

The function name mapping table 400 thus represents the mapping of function IDs to functions as used (amongst others) in the context mapping table 122 in FIG. 3. The matching component 202 and the identification component 204 may thus access the function name mapping table 400 also for resolving function IDs into function names before putting a function call to the instruction space 124.

The table 400 also allows resolving parameter IDs. For example, the ID “15” is assigned to the IP address 127.0.0.7. which in the example implementation discussed here may be the IP address of the computer of the human user Bob in a network the computing device 102 is connected with (compare with table 3 in FIG. 3, row 312). Further, the parameter IDs 134 and 135 are resolved to function parameters “ON” and “OFF”, respectively (see lines 314 in FIG. 3).

The textual representation of a function in column 404 may be such that it can be used as at least a part of a call for this function. For example, the column 404 may include the textual representation “ScanFile” because the operating system 104 of computing device 102 in FIG. 1 is adapted to handle a function call such as “ScanFile ([parameter 1]; [parameter 2])”. Brackets “(“,”)” and separators “;” may be added to the function call in later steps, as will be described below. A textual representation such as “Scan-File” or “Scan File” could not be used as a valid function call in this example, and such representations may therefore not be included in the function name mapping table.

Alternatively or in addition to representing functions in the form of function names (function calls), the function name mapping table may also provide access to an executable program code for executing a function. This is also illustrated in FIG. 4, wherein a function ID “273” is associated with a pointer “*|s”, which may point to an executable code for listing the content of a directory. The executable program code may be provided to at least one of the control device 100 and the computing device 102, e.g., in the form of one or more program libraries.

Referring to FIG. 2 again, the matching component 202 processes each of the input words 212 in the text string 116. In case a present input word is found in the irrelevant words mapping table 208, the input word is discarded. In case a present input word matches with a context mapping word in context mapping table 122, the matching component 202 buffers the input word in the context buffer 206. In case the input word directly matches with a function call in the function name mapping table 210, the matching component 202 may immediately prepare an execution of the corresponding function by, e.g., providing the textual representation of the function call specified in column 404 of table 400 or an executable program code or a link thereto to the instruction space 124.

It is to be noted that the matching component 204 may immediately place a function or a function parameter in the instruction space 124 in case an input word matches unambiguously with a function or a function parameter name given in the function name mapping table 210. As an example, consider the human user speaks an IP address such as that reference with ID “15” in the example function name mapping table 400 in FIG. 4. Upon detecting that the human user has directly input this function parameter, the matching component 202 may instantly provide this parameter to the instruction space 124.

Further, an input word may also match unambiguously with a function or function parameter in the context mapping table 122. This may be the case if a present input word matches with a context mapping word which is associated with only one function or function parameter (other functions or function parameters the context mapping word is associated with may be ruled out for other reasons). In this case also, the matching component 202 may instantly provide the function or function parameter to the instruction space 124.

After the matching component 204 has finished parsing the available input words 212, it provides a trigger signal to the identification component 204. The identification component 204 works to resolve any ambiguity which may occur due to the fact that in the context mapping table a context mapping word may be associated with multiple control functions, i.e. one or more input words cannot be matched unambiguously to one or more functions or function parameters. For this purpose the identification component 204 accesses the context mapping words which have been buffered in the context buffer 206. The component 204 identifies a function by determining buffered context mapping words associated with the same function.

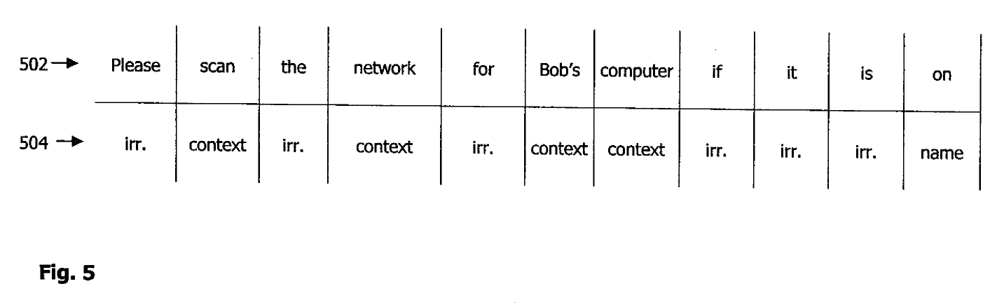

To further illustrate the operation of the context mapping component 118 of FIG. 2, in FIG. 5 a textual representation 502 of an example sentence is given which a user may speak. Line 504 in FIG. 5 indicates results of the processing of each of the input words of sentence 502 in the matching component 202 of FIG. 2. In this processing the words “please”, “the”, “for”, “if”, “it”, “is” have been identified as irrelevant (indicated as “irr.” in line 504) words, e.g. because these words are represented as irrelevant words in the irrelevant words mapping table 208. These words will not be considered in the further processing.

The input word “scan” of sentence 502 is represented as a context mapping word multiple times in the example context mapping table 122, in which “scan” is associated with the function IDs 1, 2 and 3 (reference numbers 306, 308, 310). The further input words “network” and “computer” of sentence 502 are also context mapping words associated with function IDs in table 122, namely with ID “3” (the words found by the matching component 202 to be included in the context mapping table 122 are marked “context” in line 504 in FIG. 5). The content of the context buffer 206 after the matching component 204 has parsed the entire input text string 502 is schematically illustrated in FIG. 6. All the context mapping words (or input words) “scan”, “network”, “computer” have been buffered in the context buffer 204 (column 602).

It is to be noted that in the example discussed here all input words are buffered in the context buffer 206 in case they match with any context mapping word. In other embodiments, only an input word is buffered in the context buffer which matches with a context mapping word associated with two or more functions. In such embodiments, from the input text string 502 only the word “scan” would be buffered in the context buffer. The ambiguity of which one of the functions hidden behind the function IDs 1, 2 or 3 are intended will then be resolved in a way which is different from the way described hereinafter.

When the matching component 202 buffers an input word in the context buffer 206, it also stores the function ID(s), the corresponding context mapping word is associated with, as indications of the function(s). This is depicted in column 604 in FIG. 6. For example, the context mapping word “scan” is associated with the functions referenced by function IDs 1, 2 and 3 in the context mapping table 122 (see FIG. 3). “network” and “computer” are each associated with function ID 3. The input word “Bob's” is associated with function ID (parameter ID) 15.

When parsing the input words 502, the matching component 202 finds the word “on” in the function name mapping table 210 (this is marked “name” in line 504 in FIG. 5). Function names or parameter names found in the function name mapping table may immediately put into the instruction space 124. This instruction space will be discussed next.

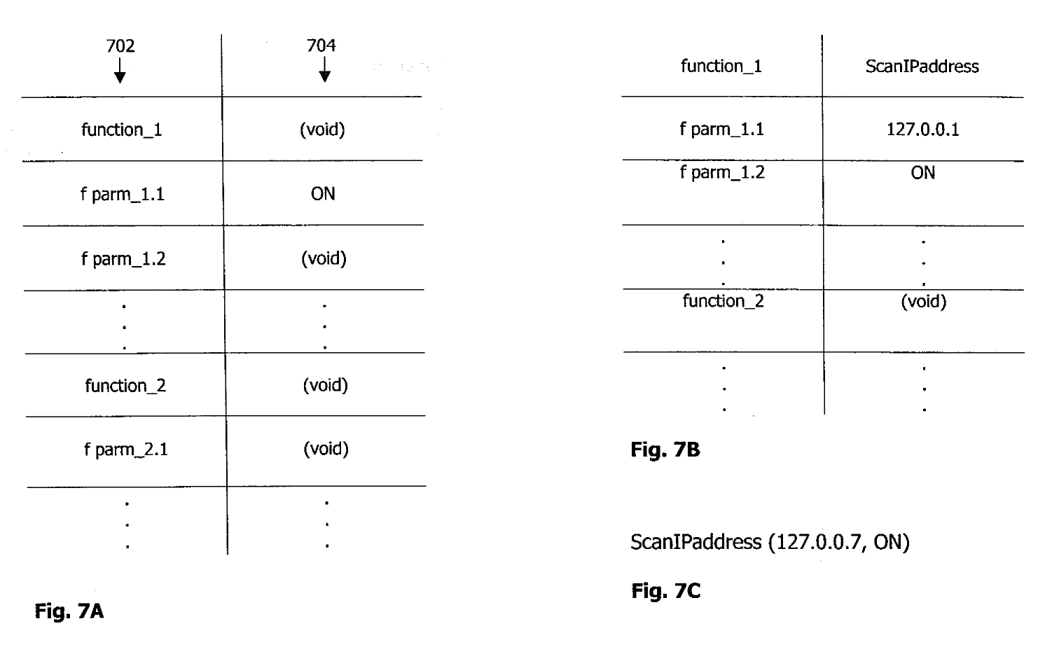

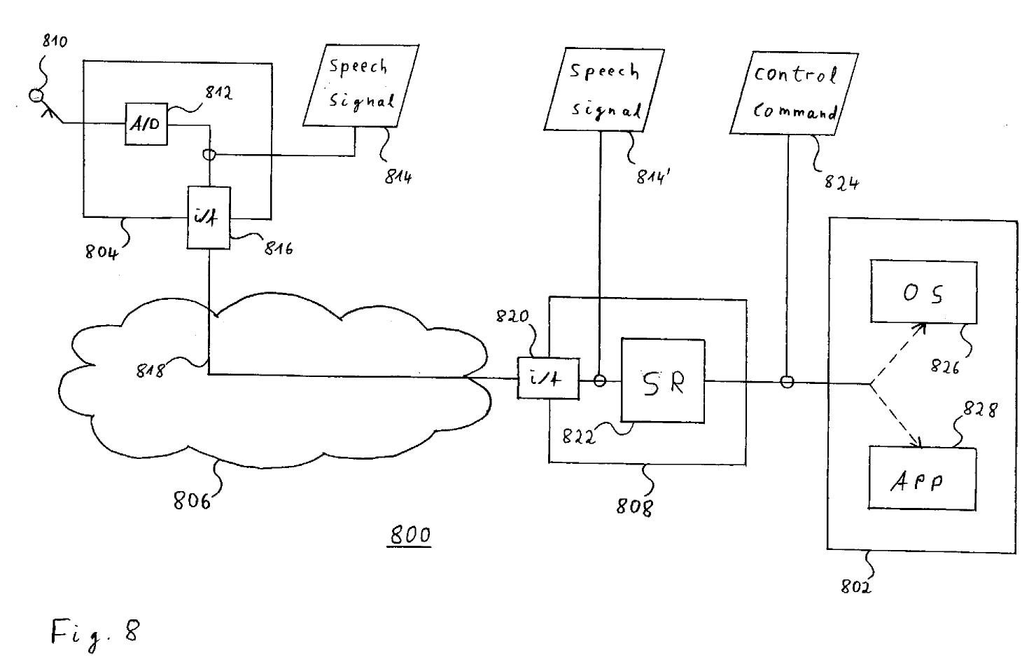

FIG. 7A schematically illustrates the status of the instruction space 124 (FIG. 4) after the matching component 204 has completed parsing the text string 502. The instruction space 124 is prepared to receive for one or more functions (“function_1”, “function_2”, etc. in column 702) and function parameters for these functions (“fparm_1.1”, “fparm_1.2” for function_1, etc.) values which may the storage place indicated as column 704 in FIG. 7 (empty storage places are illustrated as “void” places). The instruction space 124 may not explicitly contain indications such as “function_1” and “fparm_1.1”; these indications are used in the figures mainly for illustrative purposes. The instruction space may be structured in any way which allows to represent the information of a type of a stored data. For example, an identified function call may be stored in a particular storage place in the instruction space reserved for this purpose, while function parameters may be stored in a separate storage place.

At the end of parsing, the matching component 202 has only unambiguously detected the function parameter “ON” from the function name mapping table 210 (see FIG. 4). All the other matching input words have matched with context mapping words in the context mapping table 122, which is why they have been placed in the context buffer 206. Note that in a different embodiment, which is based on storing only those context mapping words in the context buffer which are associated with multiple functions or function parameters, also the parameter “Bob's” would have been replaced with the IP address defined for this parameter (FIG. 4, function ID 15) and put into the instruction space, as this parameter can unambiguously be determined.

In order to resolve the ambiguity represented in the fact that the context mapping word “scan” is associated with multiple functions, the identification component 204 analyzes the function IDs stored in the context buffer 206 (FIG. 6). The analysis may, e.g. comprise to compare the function IDs stored for the different context mapping words (column 604) and/or to determine function IDs common to several context mapping words. For the simple example illustrated in FIG. 6, the identification component 204 detects that the function ID “3” is common to the context mapping words “scan”, “network” and “computer”. The component 204 may conclude that the function referenced with ID “3” is the intended function, e.g. on the basis of the determination that the ID “3” occurs multiple times in column 604 in FIG. 6, and/or that the ID “3” is the only ID the context mapping words “network” and “computer” are associated with. The identification component 204 determines from the function name mapping table 210 the function referenced by ID “3”, namely the function “ScanIPaddress”. The component 204 puts the identified function call in the instruction space 124.

FIG. 7B illustrates the status of the instruction space 124 after the identification component 204 has entirely parsed the context buffer 206 of FIG. 6. The function “scanIPaddress” has been identified. The identification component 204 has further replaced the parameter “Bob's” by the IP address 127.0.0.7 and has put this parameter into the instruction space. Storage place provided for further functions or function parameters has not been used.

While in the simple example illustrated here only one function with two parameters is identified, in principle any number of functions and function parameters can be identified from an input text string. In practical embodiments, a context mapping table comprises a large number of functions (function IDs) and function parameters, many of them probably associated with a large number of context mapping words. For example, a context mapping table may comprise several hundred functions with several thousand function parameters and may allow up to 256 context mapping words per function/parameter. The function name mapping table, if present, then comprises a correspondingly large number of functions and function parameters.

While it is shown here that the functions are referenced with function IDs in the context mapping table, of course the functions and their parameters may also be directly referenced in the context mapping table. Instead of putting a function call in textual form in the instruction space, also a program code may be provided there, for example in textual form for later compilation or in executable form.

The identification component 206 or another component of the control device 100 or computing device 102 eventually prepares execution of the identified function. As illustrated in FIG. 7C, this may comprise to put the function call in textual form in the instruction space 124. It is to be noted that default parameters may be used in case not all parameters required for a particular function call can be identified from the input text string. The function call may instantly or at a later time be executed by the computing device 102. For example, the context mapping component 118 may provide a trigger signal (not shown in FIG. 1) to the operating system 104 of computing device 102. In response to the trigger, the operating system 104 may access the instruction space 124, extract the function call illustrated in FIG. 7C, and may than perform the function.

While in FIG. 1 it has been illustrated that the control device 100 comprises a built-in speech input device with a microphone 108 and A/D converter 110, a speech input device may as well be remotely arranged from the control device. This is exemplarily illustrated in FIG. 8, in which a system 800 for controlling a computing device 802 via speech is depicted.

The system 800 comprises a separate speech input device 804 which may be connected via a data transport network 806 with a control device 808. The speech input device 800 comprises a microphone 810 and an A/D converter 812, which outputs a digital speech signal 814 much as the A/D converter 110 in FIG. 1. The speech input device 804, which may be, e.g., a mobile phone, notebook or other mobile or stationary device, comprises a data interface 816 which is adapted to establish a data transmission connection 818 via the network 806 towards the control device 808 in order to transmit the speech data 814 from the speech input device 802 to the control device 808. The transport network 804 may for example be an IP, ISDN and/or ATM network. Therefore, the data transmission connection 818 may for example be a Voice-over-IP (VoIP), ISDN, or a Voice-over-ATM (VoATM) connection, or any other hardwired or wireless connection. For example, the connection 818 may run entirely or in part(s) over a mobile network such as a GSM or UMTS network.

The control device 808 comprises an interface 820 which is adapted to extract the speech signal 814′ from the data received via the transport connection 818. For instance, the interfaces 816 and 820 may each comprise an IP socket, an ISDN card, etc. The interface 820 forwards the speech data 814′ to a speech recognition component 822, which may or may not operate similarly to the speech recognition component 114 in FIG. 1. The further processing may comprise a context mapping as has been described hereinbefore. In the embodiment illustrated in FIG. 8, no context mapping is performed but the speech recognition component 822 operates to provide recognized words directly as control commands 824 to operating system 826 and/or an application 828 of the computing device 802.

As a concrete example, the speech input device 804 of FIG. 8 may be a mobile phone, the data transmission connection 818 may comprise a VoIP connection, and the control device 808 may be installed as a software application on a notebook exemplarily representing the computing device 802. For example, Skype may be used for the VoIP connection, and the control device application may make use of a speech recognition feature such as that provided with Windows Vista (Skype and Windows Vista are trademarks of Skype Limited and Microsoft Corp., respectively).

In still other embodiments, a speech recognition component such as the component 114 or 822 of FIG. 1 and FIG. 8, respectively, may be remotely arranged from a context mapping component such as the component 118 in FIG. 1. In these embodiments, a text string comprising one or more input words is transmitted via a data transmission connection from the speech recognition component towards the context mapping component. The considerations discussed above with respect to the embodiment 800 in FIG. 8 may be applied accordingly, except that for the transmission of a data string no VoIP, VoATM or such-like speech data transmission mechanism is required.

As a general remark, the speech recognition described as part of the techniques proposed herein may be based on any kind of speech recognition algorithm capable of converting a speech signal to a sequence of words and implemented in the form of hardware, firmware, software or a combination there from. The term ‘voice recognition’ as known to the skilled person is—in its precise meaning—directed to identifying a person who is speaking, but is often generally interchangeably used when ‘speech recognition’ is meant. In any case, the term ‘speech recognition’ as used herein may or may not include ‘voice recognition’.

Regarding a speech recognition algorithm, the respective speech recognition component, such as component 114 or 822 illustrated in FIGS. 1 and 8, respectively, may be implemented together with other components on a common hardware or on a separate or dedicated hardware unit which is connectable wireless or hardwired to other components. For example, a mobile phone or smart phone adapted for speech recognition may be used, which can be connected via USB, Bluetooth, etc. with a computing device, on which, e.g., a context mapping component such as component 118 of FIG. 1 is implemented.

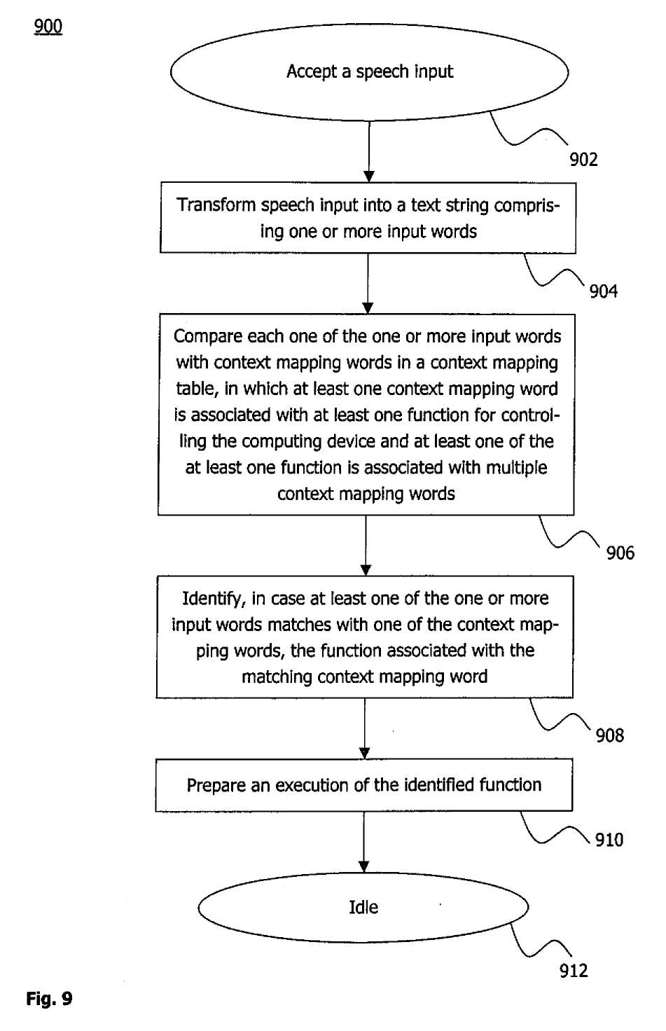

FIG. 9 is a flow diagram illustrating steps of an embodiment of a method 900 of controlling a computing device via speech. The method 900 may be performed using, e.g., the control device 100 of FIG. 1.

The method starts in step 902 with accepting a speech input, which may be provided from a speech input device such as microphone 108 and A/D converter 110 in FIG. 1.

In step 904, the speech input is transformed into a text string comprising one or more input words. This step may for example be performed in a speech recognition component such as the component 108 in FIG. 1. In step 906, each one of the one or more input words is compared with context mapping words in a context mapping table, in which at least one context mapping word is associated with at least one function for controlling the computing device and at least one of the at least one function is associated with multiple context mapping words. An example for a context mapping table is illustrated in FIG. 3. In the example control device illustrated in FIGS. 1 and 2, the step 906 is performed by the matching component 202.

In step 908, in case at least one of the one or more input words matches with one of the context mapping words, the function associated with the matching context mapping word is identified. It is to be noted that in the example configuration of FIGS. 1 and 2 the step 908 of identifying the intended function may be performed in the identification component 204, but also in the matching component 202. While the identification component 204 is adapted to resolve ambiguities by appropriately operating on the context buffer 206, the matching component 202 may identify a function in the function name mapping table 210.

In step 910, the execution of the identified function is prepared, for example by providing a call of the function or an executable program code in an instruction space such as the storage component 124 depicted in FIGS. 1 and 2. In step 912, the method 900 stops and waits for further speech input.

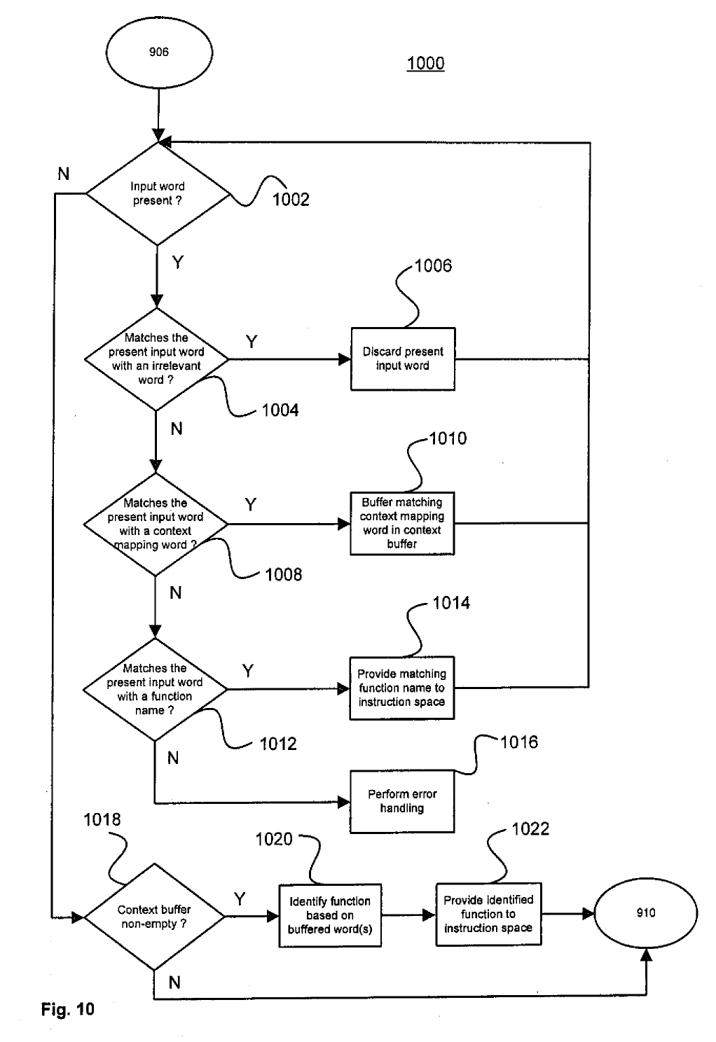

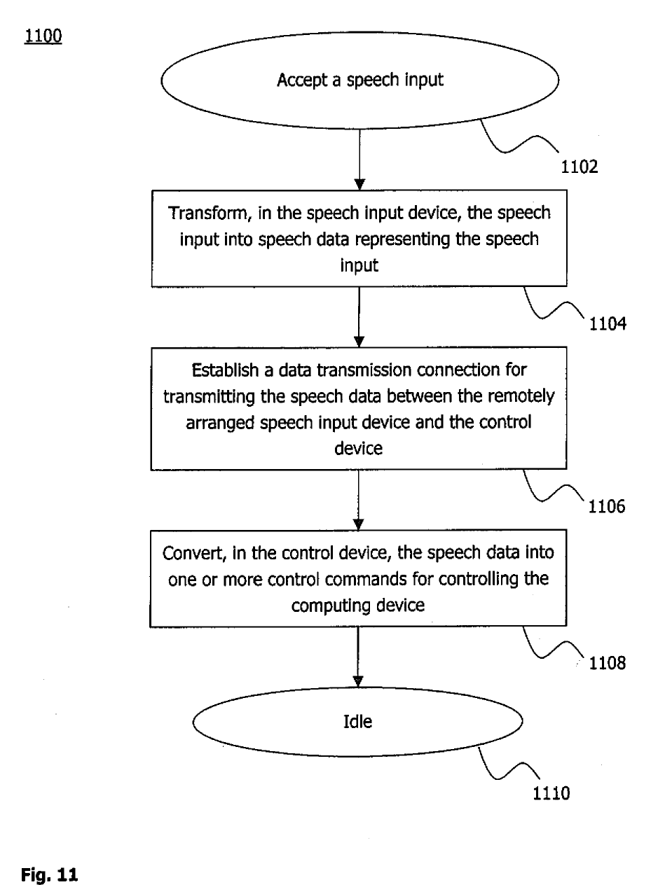

FIG. 10 is a flow diagram illustrating an embodiment of a context mapping procedure 1000. The procedure 1000 is a possible realization of at least a part of the steps 906 and 908 of FIG. 9. Essentially, procedure 1000 parses all input words of a text string such as text string 116 in FIG. 1.

In step 1002, it is determined if an input word is present. If this is the case, the procedure goes on to step 1004 wherein it is tested if the present input word is an irrelevant word, which may be determined by comparing the present word with irrelevant words stored in an irrelevant words mapping table such as table 208 illustrated in FIG. 2. In case it is determined that the present input word is an irrelevant word, in step 1006 the present word is discarded and the procedure goes back to step 1002. In case the present input word is not an irrelevant word, for example because it does not match with any word in the irrelevant words mapping table, the procedure goes on to step 1008. In this step it is tested whether the present input word matches with a context mapping word in a context mapping table such as table 122 in FIGS. 1 and 2. In case it is found that the present word matches with a context mapping word, it is buffered in step 1010 in a context buffer such as buffer 206 in FIG. 2. In a particular implementation of procedure 1000, a present input word may only be buffered in the context buffer in case the matching context mapping word is associated with at least two functions or function parameters (not shown in FIG. 10).

In case the present input word does not match with a context mapping word, the procedure goes on to step 1012 with testing if the present input word matches with a function name (or function parameter name), which may be determined by comparing the input word with the function names in a function name mapping table such as table 210 in FIGS. 2 and 4. In case the present word matches with a function name or function parameter name, the procedure goes on to step 1014 by putting the function name or function parameter name into an instruction space such as space 124 in FIGS. 1 and 2. In case the present input word is not a function name or function parameter name, some further context mapping related conditions (not shown) such as the conditions 1004, 1008, 1012 and/or an error handling 1016 may be performed. For example, the error handling 1016 may comprise to put the present input word into an irrelevant words mapping table to enable an early classification of this input word as an irrelevant word in the future. The error handling 1016 may additionally or alternatively comprise to output information to a human user and/or to ask the user for an appropriate action. Further error handling steps may be performed throughout the procedure 1000, however, only the error handling 1016 is shown in FIG. 10 for illustrative purposes.

In case the entire input text string has been parsed, the procedure goes on from step 1002 to step 1018 by testing whether the context buffer is non-empty. In case the buffer is non-empty, one or more functions and/or function parameters are identified based on buffered words. For example, a comparison of the function IDs of the buffered context mapping words may be used in this respect, as has been described further above. After having identified one or more functions/function parameters in the context buffer in step 1020, the identified function(s) and parameter(s) are put into the instruction space in step 1022 and the procedure stops by returning to step 910 of FIG. 9. It is noted that other embodiments of a context mapping procedure may depart from procedure 1000, for example, by evaluating the context mapping related conditions 1004, 1008, 1012 in different order.

FIG. 11 is a flow diagram illustrating steps of a further embodiment of a method 1100 of controlling a computing device via speech. The method 1100 may be performed in a control device and in a speech input device, wherein the speech input device is remotely arranged from the control device. For example, the method 1100 may be performed using the devices 804 and 808 of FIG. 8.

The method is triggered in step 102 in that a speech input is received and accepted at the speech input device. The method goes on in step 1104 by transforming, in the speech input device, the speech input into speech data representing the speech input. For example, the step 1104 may be performed in a microphone such as microphone 810 and an A/D converter such as converter 812 in FIG. 8. In step 1106, a data transmission connection is established for transmitting the speech data between the remotely arranged speech input device and the control device. For example, a data transmission connection such as connection 818 in FIG. 8 between interfaces 816 and 820 of the speech input device 804 and the control device 808 may be established. The speech data may then be transmitted from the speech input device via the remote connection to the control device.

In step 1108, the speech data is converted in the control device into one or more control commands for controlling the computing device. In one implementation, the conversion step 1108 comprises speech recognition and context mapping as described hereinbefore with regard to the functionality of the components 114 and 118 of FIG. 1. In other embodiments, only a speech recognition as implemented in the speech recognition component 114 in FIG. 1 is performed without any context mapping. In this case, the user may only speak commands he or she would otherwise enter by typing or by clicking on an appropriate button.

Instead of only providing a one-to-one mapping of spoken command to machine-readable command, the context-mapping related techniques proposed herein allow the user to describe a command or function within various contexts, i.e. they propose to introduce redundancy into the speech recognition/control process. The user is not required to speak exactly the same command he or she would otherwise type, but may describe the intended command or function in his own words, in different languages, or in any other context. The deployed speech control device or system needs to be appropriately configured, e.g. by providing the relevant context mapping words in the context mapping table. In this way the proposed techniques allows to provide a more reliable speech control.

The context-related descriptions or circumscriptions of the user may of course also be related to more than only one function or command. For example, a spoken request “Please search for Search_item” may be transformed and converted into a function or functions searching for accordingly named files and occurrences of ‘Search_item’ in files present locally on the computing device, but may further be converted and transformed into a function searching a local network and/or the web for ‘Search_Item’. Further, the same function may also be performed multiple times, for example when transforming and converting the sentence “Please scan the network for my friend's computers, if they are on”, in which “friend's” may be transformed into a list of IP addresses to be used in consecutive network searches. Therefore, the proposed techniques are also more powerful than speech recognition techniques providing only a one-to-one mapping of spoken commands to machine commands.

The proposed speech control devices and systems are more user-friendly, as they may not require the user to know machine-specific or application-specific commands. An appropriately configured device or system is able to identify functions or commands described by users not common with technical terms. For this reason, the speech input is also simplified for the user; the user may just describe in his own terms what he or she wants the computing device to do. This at the same time accelerates speech control, as a user allowed to talk in his or her own terms may produce fewer errors, which reduces wrong inputs.

The techniques proposed herein do not use excessive resources. Smaller control devices and systems may be developed in any programming language and make use of storage resources in the usual ways. Control devices and systems intended for larger function sets may be based on existing database technologies. The techniques are applicable for implementation on single computing devices such as mobile phones or personal computers as well as for implementation in a network-based client-server architecture.

The techniques proposed herein also provide an increased flexibility for speech control. This is due to the fact that any device providing a speech input and speech data transmission facility, such as a mobile phone, but also many notebooks or conventional hardwired telephones may be used as speech input device, while the speech recognition and optional context mapping steps may be performed either near to the computing device to be controlled or at still another place, for example at a respective node (e.g., server) in a network.

While the current invention has been described in relation to its preferred embodiments, it is to be understood that this disclosure is for illustrative purposes only. Accordingly, it is intended that the invention be limited only by the scope of the claims appended hereto.

1. A method of controlling a computing device via speech, comprising the following steps:
transforming speech input into a text string comprising one or more input words;
comparing each one of the one or more input words with context mapping words in a context mapping table, in which at least one context mapping word is associated with at least one function for controlling the computing device and at least one of the at least one function is associated with multiple context mapping words;
identifying, in case at least one of the one or more input words matches with one of the context mapping words, the function associated with the matching context mapping word; and
preparing an execution of the identified function.

2. The method according to claim 1,
wherein a context mapping word represents in textual form an aspect of the functionality of the function the context mapping word is associated with.

3. The method according to claim 1,
wherein multiple context mapping words associated with a function represent alias names of the function the context mapping words are associated with.

4. The method according to claim 1,
wherein context mapping words represent a function or one or more aspects of it in different human languages.

5. The method according to claim 1,
wherein a context mapping word is associated with a function parameter.

6. The method according to claim 1,
wherein the step of preparing the execution of the identified function comprises at least one of providing a text string representing a call of the identified function and providing an executable program code representing the identified function on the computing device.

7. The method according to claim 1,
wherein the step of identifying the function comprises, in case an input word matches a context mapping word associated with multiple functions, identifying one function of the multiple functions which is associated with multiple matching context mapping words.

8. The method according to claim 7,
wherein the step of comparing each one of the one or more input words with context mapping words comprises the step of buffering an input word in a context buffer in case the input word matches a context mapping word that is associated with two or more functions.

9. The method according to claim 8,
wherein the step of buffering the input word comprises buffering the input word in the context buffer including, for each of the two or more functions or function parameters associated with the input word, an indication of the function or function parameter.

10. The method according to claim 9,
wherein the step of identifying the function comprises comparing indications of functions or function parameters of two or more input words buffered in the context buffer and identifying corresponding indications.

11. The method according to claim 1,
comprising the further step of comparing an input word with function names in a function name mapping table, in which each of the function names represents one of the functions for controlling the computing device.

12. The method according to claim 11,
comprising the further step of identifying, in case the input word matches with at least a part of a function name, the function associated with the at least partly matching function name.

13. The method according to claim 11,
wherein the function name mapping table further comprises function parameters for comparing the function parameters with input words.

14. The method according to claim 11,
wherein entries corresponding to the same function or function parameter in the context mapping table and the function name mapping table are linked with each other.

15. The method according to claim 14,
wherein a linked entry in the function name mapping table is associated with executable program code representing at least a part of a function.

16. The method according to claim 1,
comprising the further steps of
comparing input words with irrelevant words in an irrelevant words mapping table; and
in case an input word matches with an irrelevant word, excluding the input word from identifying the function.

17. A method of controlling a computing device via speech, wherein the method is performed in a control device and in a speech input device remotely arranged from the control device, the method comprising the steps of
transforming, in the speech input device, speech input into speech data representing the speech input;
establishing a data transmission connection for transmitting the speech data between the remotely arranged speech input device and the control device; and
converting, in the control device, the speech data into one or more control commands for controlling the computing device.

18. A computer program product comprising program code portions for performing the steps of claim 1 when the computer program product is executed on one or more computing devices.

19. The computer program product of claim 18, stored on a computer readable recording medium.

20. A control device for controlling a computing device via speech, comprising:
a speech recognition component adapted to transform speech input into a text string comprising one or more input words;
a matching component adapted to compare each one of the one or more input words with context mapping words in a context mapping table, in which at least one context mapping word is associated with at least one function for controlling the computing device and at least one of the at least one function is associated with multiple context mapping words;
an identification component adapted to identify, in case at least one of the one or more input words matches with one of the context mapping words, the function associated with the matching context mapping word; and
a preparation component adapted to prepare an execution of the identified function.

21. The control device according to claim 20,
the control device being implemented on the mobile or stationary computing device.

22. A system for controlling a computing device via speech, wherein the system comprises a control device and a speech input device; and
the speech input device is adapted to transform speech input into speech data representing the speech input;
the control device is adapted to convert the speech data into one or more control commands for controlling the computing device; and
each of the speech input device and the control device comprises a data interface adapted to establish a data transmission connection for transmitting the speech data between the remotely arranged speech input device and the control device.
